(19) United States
(12) Patent Application Publication
(10) Pub. No.: US 2018/0147898 A1
(43) Pub. Date: May 31, 2018

(54) PNEUMATIC TIRE

(71) Applicant: Toyo Tire & Rubber Co., Ltd., Itami-shi (JP)

(72) Inventor: Seiji Yokomakura, Itami-shi (JP)

(73) Assignee: Toyo Tire & Rubber Co., Ltd., Itami-shi (JP)

(21) Appl. No.: 15/805,349

(22) Filed: Nov. 7, 2017

(30) Foreign Application Priority Data
Nov. 28, 2016 (JP) 2016-230232

(51) Int. Cl. B60C 15/06

(52) U.S. Cl. CPC B60C 15/0635; B60C 2015/0692; B60C 2015/0678

(57) ABSTRACT

A pneumatic tire includes a carcass ply that is wound up around a bead core from an inside to an outside in a tire axial direction; an inner metal reinforcing layer and an outer metal reinforcing layer that are wound up on an outside of the carcass ply from the inside to the outside in the tire axial direction; and a buffer layer that is provided between the inner metal reinforcing layer and the outer metal reinforcing layer, and is wound up from the inside to the outside in the tire axial direction. The buffer layer includes a rubber having a higher hardness than those of a carcass rubber configuring the carcass ply and a covering rubber configuring the inner metal reinforcing layer and the outer metal reinforcing layer.

### BACKGROUND OF THE INVENTION

### Field of the Invention

The present invention relates to a pneumatic tire.

### Background Art

In a pneumatic tire, particularly, a heavy duty pneumatic tire, it is required to improve durability of a bead portion. In order to improve the durability of the bead portion, it is effective to suppress deformation of the bead portion and to reduce distortion at a winding-up end of a carcass ply. Therefore, a pneumatic tire having a metal reinforcing layer including a metal cord provided along an outside of a carcass ply around a bead core is proposed in JP-A-5-155208 and JP-A-2008-195339.

In JP-A-5-155208 and JP-A-2008-195339, in order to enhance a reinforcing effect in a bead portion, two metal reinforcing layers are provided along the outside of the carcass ply. However, if the two metal reinforcing layers are provided around the bead core, large shear strain is likely to occur between the two metal reinforcing layers. Therefore, the stress concentrates on an end portion of the metal reinforcing layer and the durability of the bead portion may deteriorate.

In the bead portion, large shear strain acts between a rim flange and a portion called a rim strip which is in contact with the rim flange. As described above, if the two metal reinforcing layers are provided around the bead core, since rigidity of the bead portion is increased, the shear strain generated between the rim flange and the portion is unlikely to be dispersed over the entire rim strip and may locally act on the rim strip, and the rim strip rubs against the rim flange and becomes easy to be worn.

### SUMMARY OF THE INVENTION

The invention is made in view of the above-described points and an object of the invention is to provide a pneumatic tire capable of improving durability of a bead portion without impairing the wear resistance to a rim flange.

According to an aspect of the present invention, there is provided a pneumatic tire including a bead core that is embedded in a bead portion; a bead filler that is disposed on an outside of the bead core in a tire radial direction; a carcass ply that is wound up around the bead core from an inside to the outside in a tire axial direction; an inner metal reinforcing layer that is wound up on an outside of the carcass ply from the inside to the outside in the tire axial direction; an outer metal reinforcing layer that is wound up on an outside of the inner metal reinforcing layer from the inside to the outside in the tire axial direction; and a buffer layer that is provided between the inner metal reinforcing layer and the outer metal reinforcing layer, and is wound up from the inside to the outside in the tire axial direction. The carcass ply includes a ply cord and a carcass rubber covering the ply cord, the inner metal reinforcing layer and the outer metal reinforcing layer include metal cords and covering rubbers that cover the metal cords, and the buffer layer includes a rubber having a higher hardness than those of the carcass rubber and the covering rubber.

### BRIEF DESCRIPTION OF THE DRAWINGS

FIG. 1 is a half sectional view of a tire meridian illustrating a pneumatic tire of a first embodiment.

FIG. 2 is an enlarged view of a bead portion of FIG. 1.

FIG. 3 is a schematic view illustrating inclination angles and inclination directions of a metal cord included in an inner metal reinforcing layer and an outer metal reinforcing layer with respect to a ply cord of the pneumatic tire of FIG. 1.

FIG. 4 is an enlarged sectional view of a tire meridian illustrating a bead portion of a pneumatic tire of a second embodiment.

FIG. 5 is an enlarged sectional view of a tire meridian illustrating a bead portion of a pneumatic tire of Comparative Example 1.

FIG. 6 is an enlarged sectional view of a tire meridian illustrating a bead portion of a pneumatic tire of Comparative Example 2.

FIG. 7 is an enlarged sectional view of a tire meridian illustrating a bead portion of a pneumatic tire of Comparative Example 3.

### DETAILED DESCRIPTION OF THE INVENTION

### First Embodiment

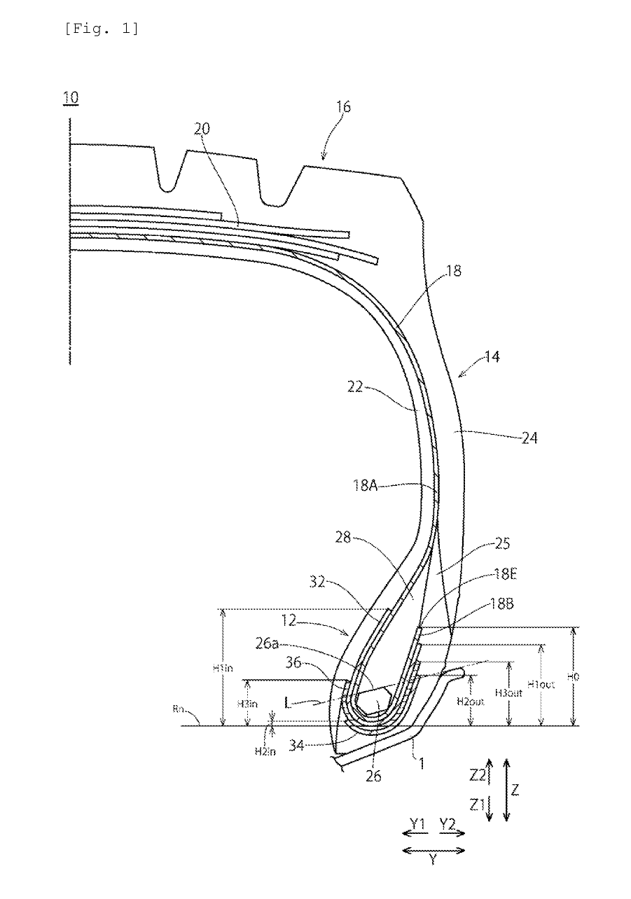

Hereinafter, an embodiment of the invention will be described with reference to the drawings. FIG. 1 is a sectional view of a tire meridian illustrating an example of a pneumatic tire (hereinafter, referred to as the “tire”) 10 of a first embodiment and illustrates a half section in a state where the tire 10 is mounted on a rim flange 1 of a normal rim.

In the present specification, a tire axial direction is a direction parallel to a tire rotational axis, has the same meaning as a tire width direction, and is indicated by a symbol Y in the drawings, and an inside and an outside in the tire axial direction are respectively indicated by symbols Y1 and Y2. In addition, a tire radial direction (radial direction) is a direction perpendicular to the tire rotational axis and is indicated by a symbol Z in the drawings, and an inside and an outside in the tire radial direction are respectively indicated by symbols Z1 and Z2.

In addition, in the present specification, positions of an winding-up end 18E of a carcass ply 18, an outside end 32Eout and an inside end 32Ein of an inner metal reinforcing layer 32 in the tire axial direction, an outside end 34Eout and an inside end 34Ein of an outer metal reinforcing layer 34 in the tire axial direction, and an outside end 36Eout and an inside end 36Ein of a buffer layer 36 in the tire axial direction are positions in a normal state with no load in which the tire is mounted on the normal rim and is filled with air at a normal internal pressure. The normal rim is a “Measuring rim” in the JATMA standard, a “Design Rim” in the TRA standard, and a “Measuring Rim” in the ETRTO standard. The normal internal pressure is a “maximum air pressure” in the JATMA standard, a “maximum value” in the description of “TIRE LOAD LIMITS AT VARIOUS COLD INFLATION PRESSURES” in the TRA standard, and an “INFLATION PRESSURE” in the ETRTO standard.

The tire 10 according to the embodiment includes a pair of right and left bead portions 12, a pair of side wall portions 14 extending outward from the bead portions 12 in the tire radial direction, and a tread portion 16 provided between the both side wall portions 14 so as to connect outside end portions of the right and left side wall portions 14 in the radial direction.

The carcass ply 18 extending between a pair of the bead portions 12 is embedded inside the tire 10. The carcass ply 18 extends from the tread portion 16 through the side wall portions 14 and both end portions are locked at the bead portions 12. A belt 20 is provided on an outer peripheral side of the carcass ply 18 in the tread portion 16. The belt 20 reinforces the tread portion 16 at the outer periphery of the carcass ply 18. The carcass ply 18 is formed by covering ply cords 19 arranged along a direction (that is, the tire axial direction Y) substantially orthogonal to a tire circumferential direction F with a carcass rubber. As the ply cord 19, a metal cord such as a steel cord or an organic fiber cord is used.

An inner liner 22 as an air permeability resistant rubber layer configuring an inner peripheral surface of the tire 10 is provided on an inside of the carcass ply 18. In the side wall portion 14, a side wall rubber 24 configuring an outer wall surface of the tire 10 is provided on an outside of the carcass ply 18. In addition, a rim strip 25, which is in contact with the rim flange 1 on the outside of the bead portion 12 in the tire axial direction, is provided on the inside of the side wall rubber 24 in the tire radial direction.

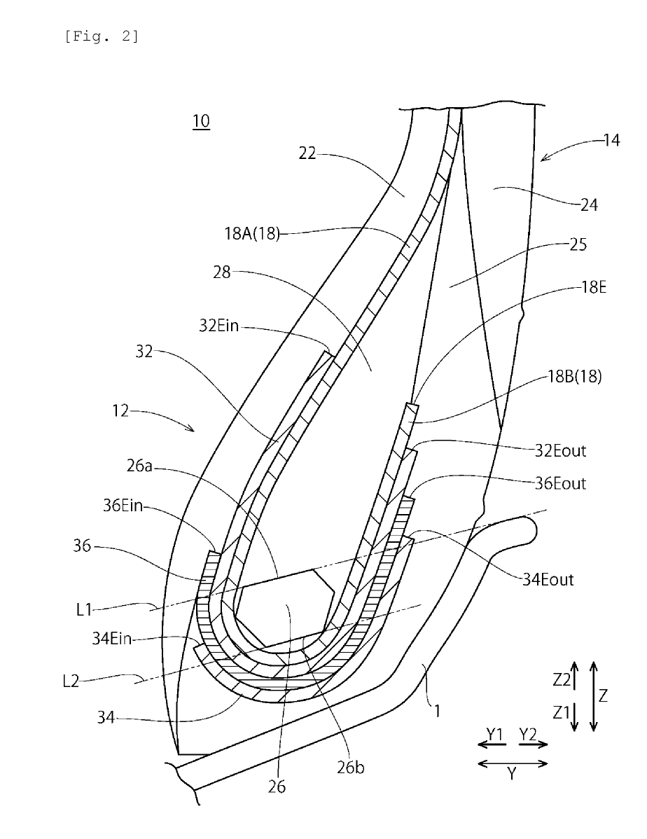

As illustrated in an enlarged view of FIG. 2, an annular bead core 26 made of a convergent body in which rubber-coated bead wires are laminated and wound, and a bead filler 28 made of rubber disposed on the outside Z2 of the bead core 26 in the tire radial direction are embedded in the bead portion 12.

The carcass ply 18 includes a body portion 18A extending from the side wall portion 14 and a winding-up portion 18B wound up around the bead core 26 from the inside Y1 to the outside Y2 in the tire axial direction. More specifically, the body portion 18A of the carcass ply 18 is disposed along inner surfaces of the bead core 26 and the bead filler 28 in the tire axial direction. The body portion 18A is wound up to the outside Y2 in the tire axial direction through the inside (lower side in FIGS. 1 and 2) Z1 of the bead core 26 in the tire radial direction and is integrally connected to the winding-up portion 18B.

The winding-up portion 18B of the carcass ply 18 is disposed along the outside surfaces of the bead core 26 and the bead filler 28 in the tire axial direction, and a tip (that is, an outside end of the winding-up portion 18B in the tire radial direction) thereof becomes the winding-up end 18E.

Two metal reinforcing layers (the inner metal reinforcing layer 32 and the outer metal reinforcing layer 34 in the embodiment) including metal cords 33 and 35, and the buffer layer 36 provided between the inner metal reinforcing layer 32 and the outer metal reinforcing layer 34 are provided around the carcass ply 18 in the bead portion 12.

The inner-metal reinforcing layer 32 is formed by covering the metal cord 33 such as a steel cord with covering rubber. The inner metal reinforcing layer 32 is wound up on outside of the carcass ply 18 from the inside Y1 to the outside Y2 in the tire axial direction and is provided so as to overlap the carcass ply 18 to cover the outside of the carcass ply 18 around the bead core 26.

The outer metal reinforcing layer 34 is formed by covering the metal cord 35 such as a steel cord with covering rubber. The outer metal reinforcing layer 34 is wound up on outside of the buffer layer 36 from the inside Y1 to the outside Y2 in the tire axial direction and is provided so as to overlap the buffer layer 36 to cover the outside of the buffer layer 36 around the bead core 26.

Moreover, in the example, the metal cord 35 and the covering rubber configuring the outer metal reinforcing layer 34 are made of the same material as that of the metal cord 33 and the covering rubber configuring the inner metal reinforcing layer 32, but may be made of a different material from that of the metal cord 33 and the covering rubber configuring the inner metal reinforcing layer 32.

The buffer layer 36 is wound up on outside of the inner metal reinforcing layer 32 from the inside Y1 to the outside Y2 in the tire axial direction and is provided so as to overlap the inner metal reinforcing layer 32 to cover the outside of the inner metal reinforcing layer 32 around the bead core 26.

Rubber configuring the buffer layer 36 has higher rubber hardness after vulcanization than that of the carcass rubber configuring the carcass ply 18, the covering rubber configuring the inner metal reinforcing layer 32, or the covering rubber configuring the outer metal reinforcing layer 34. In the embodiment, the rubber hardness of the carcass rubber or the covering rubber configuring the inner metal reinforcing layer 32 and the outer metal reinforcing layer 34 is set to 75, and the rubber hardness of the rubber configuring the buffer layer 36 is set to 85. Of course, the invention is not limited to the example, and for example, the rubber hardness of the carcass rubber or the covering rubber configuring the inner metal reinforcing layer 32 and the outer metal reinforcing layer 34 may be, for example, 70 to 79. The rubber hardness of the rubber configuring the buffer layer 36 may be, for example, 80 to 90.

Here, the rubber hardness is a value (durometer hardness) measured with a type A durometer in an atmosphere at 23° C. in accordance with JIS K6253.

There is no particular limitation on a method of providing such hardness difference. For example, the rubber hardness may be increased by changing the type of rubber component to be used, increasing an amount of filler such as carbon black or silica, or increasing a vulcanizing agent or a vulcanizing accelerator.

The tips (hereinafter, referred to as the outside ends in the tire axial direction) 32Eout, 34Eout, and 36Eout of the inner metal reinforcing layer 32, the outer metal reinforcing layer 34, and the buffer layer 36 positioned on the outside Y2 from the bead core 26 (or the bead filler 28) in the tire axial direction are positioned on the outside Z2 in the tire radial direction from a bead upper side line L1 obtained by extending an outside surface 26a of the bead core 26 in the tire radial direction. In a state where the tire 10 is mounted on the rim flange 1, the inner metal reinforcing layer 32, the outer metal reinforcing layer 34, and the buffer layer 36 face an entire portion being in contact with the rim strip 25 with the rim strip 25 interposed therebetween in the rim flange 1.

The outside end 32Eout of the inner metal reinforcing layer 32 in the tire axial direction is positioned on the outside Z2 in the tire radial direction from the outside end 34Eout of the outer metal reinforcing layer 34 in the tire axial direction or the outside end 36Eout of the buffer layer 36 in the tire axial direction, and is positioned on the inside Z1 in the tire radial direction from the winding-up end 18E of the carcass ply 18. The outside end 36Eout of the buffer layer 36 in the tire axial direction is positioned on the outside Z2 in the tire radial direction from the outside end 34Eout of the outer metal reinforcing layer 34 in the tire axial direction.

Therefore, the outside end 32Eout, 34Eout, and 36Eout of each layer in the tire axial direction are disposed to be displaced in the tire radial direction Z so that the winding-up end 18E of the carcass ply 18, the outside end 32Eout of the inner metal reinforcing layer 32 in the tire axial direction, the outside end 36Eout of the buffer layer 36 in the tire axial direction, and the outside end 34Eout of the outer metal reinforcing layer 34 in the tire axial direction are positioned in this order from the outside Z2 in the tire radial direction.

In addition, the tips (hereinafter, referred to as the inside ends in the tire axial direction) 32Ein, 34Ein, and 36Ein of the inner metal reinforcing layer 32, the outer metal reinforcing layer 34, and the buffer layer 36 positioned on the inside Y1 in the tire axial direction from the bead core 26 (or the bead filler 28) are positioned on the outside Z2 in the tire radial direction from a bead lower side line L2 obtained by extending an inside surface 26b of the bead core 26 in the tire radial direction. The inside end 32Ein and 36Ein of the inner metal reinforcing layer 32 and the buffer layer 36 in the tire axial direction are positioned on the outside Z2 in the tire radial direction from the bead upper side line L1.

Here, as an example of the positions of the end portions of the carcass ply 18, the inner metal reinforcing layer 32, the outer metal reinforcing layer 34, and the buffer layer 36 with reference to FIG. 1, a length H0 in the tire radial direction Z from a nominal diameter Rn to the winding-up end 18E of the carcass ply 18 can be set to 38 mm, a length H1in in the tire radial direction Z from, the nominal diameter Rn to the inside end 32Ein of the inner metal reinforcing layer 32 in the tire axial direction can be set to 45 mm, a length H1out in the tire radial direction Z from the nominal diameter Rn to the outside end 32Eout of the inner metal reinforcing layer 32 in the tire axial direction can be set to 30 mm, a length H2in in the tire radial direction Z from the nominal diameter Rn to the inside end 34Ein of the outer metal reinforcing layer 34 in the tire axial direction can be set to 5 mm, a length H2out in the tire radial direction Z from the nominal diameter Rn to the outside end 34Eout of the outer metal reinforcing layer 34 in the tire axial direction can be set to 20 mm, a length H3in in the tire radial direction Z from the nominal diameter Rn to the inside end 36Ein of the buffer layer 36 in the tire axial direction can be set to 15 mm, and a length H3out in the tire radial direction Z from the nominal diameter Rn to the outside end 36Eout of the buffer layer 36 in the tire axial direction can be set to 25 mm.

The inclination angles and the inclination directions of the metal cords 33 and 35 included in the inner metal reinforcing layer 32 and the outer metal reinforcing layer 34 are set as follows.

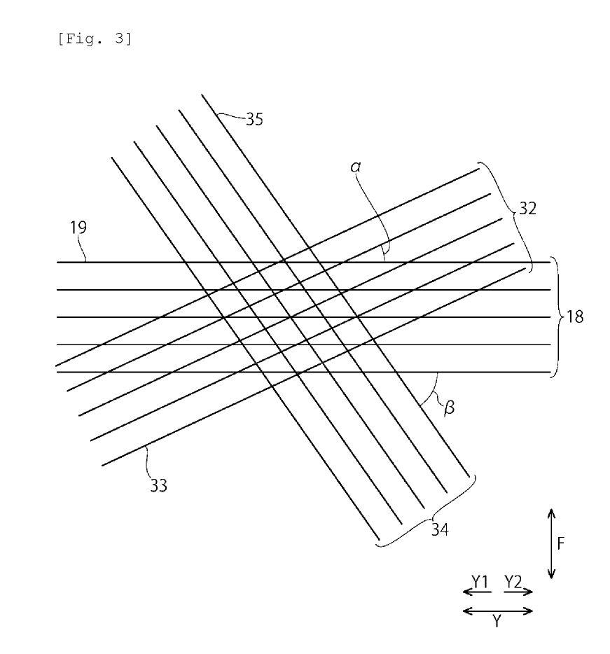

FIG. 3 illustrates the inclination angles and the inclination directions of the metal cords 33 and 35 with respect to the ply cord 19 of the carcass ply 18 in a state where the carcass ply 18, the inner metal reinforcing layer 32, and the outer metal reinforcing layer 34 are developed in the bead portion 12.

As illustrated in FIG. 3, the metal cord 33 of the inner metal reinforcing layer 32 and the metal cord 35 of the outer metal reinforcing layer 34 are inclined and intersect each other in the opposite direction with respect to the ply cord 19 of the carcass ply 18. In the embodiment, the metal cord 33 of the inner metal reinforcing layer 32 has an angle α of +25° with respect to the ply cord 19 of the carcass ply 18. The metal cord 35 of the outer metal reinforcing layer 34 has an angle β of −55° with respect to the ply cord 19 of the carcass ply 18. Of course, the invention is not limited to the embodiment. The metal cord 33 of the inner metal reinforcing layer 32 can be set to the angle α of +15° to +35° with respect to the ply cord 19 of the carcass ply 18. The metal cord 35 of the outer metal reinforcing layer 34 can be set to the angle β of −40° to −70° with respect to the ply cord 19 of the carcass ply 18. In addition, the intersection angle between the metal cord 33 and the metal cord 35 of the inner metal reinforcing layer 32 and the outer metal reinforcing layer 34 is preferably close to a right angle, and the intersection angle between the metal cord 33 and the metal cord 35 is preferably in a range of 50° to 105°.

Moreover, in the embodiment, the metal cord 33 of the inner metal reinforcing layer 32 has an angle of +15° to +35° with respect to the ply cord 19 of the carcass ply 18, but the angle with respect to the ply cord 19 may be exchanged between the inner metal reinforcing layer 32 and the outer metal reinforcing layer 34. That is, the angle α of the inner metal reinforcing layer 32 may be −40° to −70° and the angle β of the outer metal reinforcing layer 34 may be +15° to +35°.

As described above, in the embodiment, the buffer layer 36, which includes the rubber having the higher rubber hardness after vulcanization than that of the covering rubber configuring the inner metal reinforcing layer 32 and the outer metal reinforcing layer 34, is provided between the inner metal reinforcing layer 32 and the outer metal reinforcing layer 34. Therefore, the shear strain generated between the inner metal reinforcing layer 32 and the outer metal reinforcing layer 34 is reduced by the buffer layer 36 so that it is possible to suppress the concentration of stress at the end portions of the inner metal reinforcing layer 32 and the outer metal reinforcing layer 34, and to improve durability of the bead portion.

Furthermore, the shear strain generated between the rim flange 1 and the rim strip 25 during running is more easily dispersed over the entire rim strip by the buffer layer 36 and wear of the rim strip 25 can be suppressed.

In addition, in the embodiment, the outside end 32Eout of the inner metal reinforcing layer 32 in the tire axial direction, the outside end 36Eout of the buffer layer 36 in the tire axial direction, and the outside end 34Eout of the outer metal reinforcing layer 34 in the tire axial direction are positioned on the outside in the tire radial direction from the bead upper side line L1 of the bead core 26. That is, in a state where the tire 10 is mounted on the rim flange 1, the inner metal reinforcing layer 32, the outer metal reinforcing layer 34, and the buffer layer 36 face the entire portion being in contact with the rim strip 25 with the rim strip 25 interposed therebetween in the rim flange 1. Therefore, the inner metal reinforcing layer 32 and the outer metal reinforcing layer 34 with the buffer layer 36 interposed therebetween can be provided over an entire portion which is in contact with the rim flange 1 and is likely to receive stress, and wear of the rim strip 25 can be suppressed while effectively reducing the shear strain generated between the inner metal reinforcing layer 32 and the outer metal reinforcing layer 34.

In addition, in the embodiment, the winding-up end 18E of the carcass ply 18, the outside end 32Eout of the inner metal reinforcing layer 32 in the tire axial direction, the outside end 36Eout of the buffer layer 36 in the tire axial direction, and the outside end 34Eout of the outer metal reinforcing layer 34 in the tire axial direction are positioned to be shifted in the tire radial direction Z. Therefore, the reinforcing effect by the carcass ply 18, the inner metal reinforcing layer 32, and the outer metal reinforcing layer 34 can be gradually reduced as going to the outside Z2 in the tire radial direction and it is possible to suppress the stress concentration of the shear strain on the outside of the bead portion 12 in the tire axial direction, and to improve the durability.

### Second Embodiment

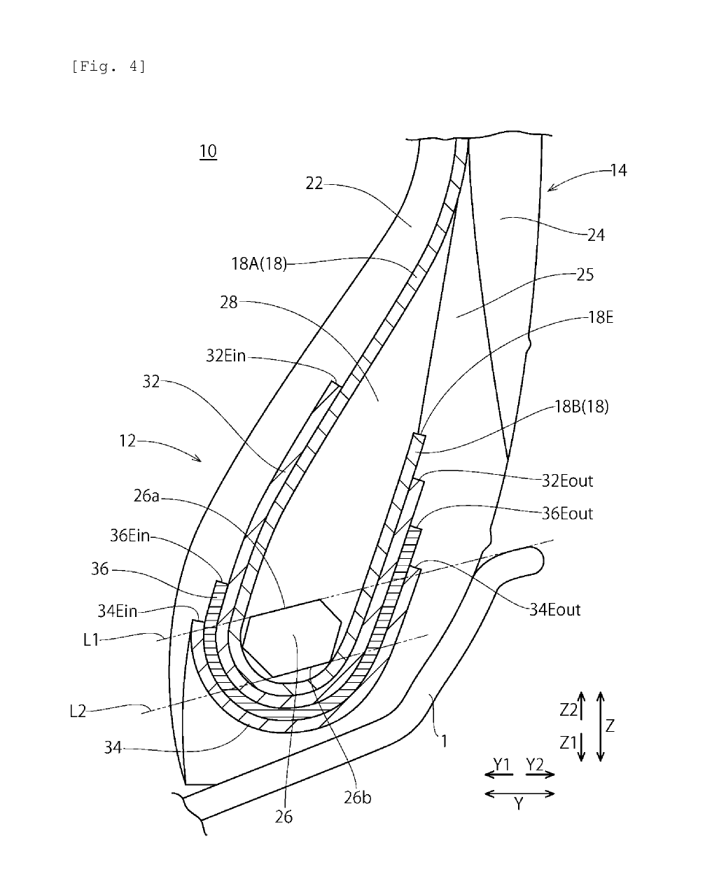

Next, a second embodiment of the invention will be described with reference to FIG. 4. Moreover, the description of the same portions as those of the first embodiment is omitted and different portions are described.

In the embodiment, a position of an inside end 34Ein of an outer metal reinforcing layer 34 in the tire axial direction provided in a bead portion 12 is different from that of the first embodiment.

Specifically, the inside ends 32Ein, 34Ein, and 36Ein of an inner metal reinforcing layer 32, an outer metal reinforcing layer 34, and a buffer layer 36 in the tire axial direction are positioned on an outside Z2 in the tire radial direction from a bead upper side line L1.

The inside end 32Ein of the inner metal reinforcing layer 32 in the tire axial direction is positioned on the outside Z2 in the tire radial direction from a winding-up end 18E of the carcass ply 18, the inside end 34Ein of the outer metal reinforcing layer 34 in the tire axial direction, or the inside end 36Ein of the buffer layer 36 in the tire axial direction. The inside end 36Ein of the buffer layer 36 in the tire axial direction is positioned on the outside Z2 in the tire radial direction from the inside end 34Ein of the outer metal reinforcing layer 34 in the tire axial direction.

Therefore, the inner metal reinforcing layer 32, the outer metal reinforcing layer 34, and the buffer layer 36 are disposed so as to wrap an inner portion of the bead core 26 in the tire radial direction. The inside ends 32Ein, 34Ein, and 36Ein of each layer in the tire axial direction are disposed to be shifted in the tire radial direction Z so that the inside end 32Ein of the inner metal reinforcing layer 32 in the tire axial direction, the winding-up end 18E of the carcass ply 18, the inside end 36Ein of the buffer layer 36 in the tire axial direction, and the inside end 34Ein of the outer metal reinforcing layer 34 in the tire axial direction are positioned in this order from the outside Z2 in the tire radial direction.

As described above, in the embodiment, in addition to outside ends 32Eout, 34Eout, and 36Eout of the inner metal reinforcing layer 32, the outer metal reinforcing layer 34, and the buffer layer 36 in the tire axial direction, the inside ends 32Ein, 34Ein, and 36Ein of the inner metal reinforcing layer 32, the outer metal reinforcing layer 34, and the buffer layer 36 in the tire axial direction are positioned on the outside Z2 in the tire radial direction from a bead upper side line L1. The inner metal reinforcing layer 32, the outer metal reinforcing layer 34, and the buffer layer 36 are disposed so as to wrap the inner portion of the bead core 26 in the tire radial direction. Therefore, the reinforcing effect by the inner metal reinforcing layer 32 and the outer metal reinforcing layer 34 can be increased and it is possible to improve the durability of the bead portion.

In addition, in the embodiment, the inside end 32Ein of the inner metal reinforcing layer 32 in the tire axial direction, the inside end 36Ein of the buffer layer 36 in the tire axial direction, and the inside end 34Ein of the outer metal reinforcing layer 34 in the tire axial direction are positioned to be shifted in the tire radial direction Z. Therefore, the reinforcing effect by the inner metal reinforcing layer 32 and the outer metal reinforcing layer 34 can be gradually reduced as going to the outside Z2 in the tire radial direction and it is possible to suppress the stress concentration of the shear strain on the inside of the bead portion 12 in the tire axial direction, and to improve the durability.

Moreover, other configurations and operational effects are the same as those of the first embodiment and detailed description thereof will be omitted.

### Other Embodiments

In the first embodiment and the second embodiment, a case where the buffer layer 36 provided between the inner metal reinforcing layer 32 and the outer metal reinforcing layer 34 is made of the rubber having higher rubber hardness after vulcanization than that of the carcass rubber configuring the carcass ply 18 or the covering rubber configuring the inner metal reinforcing layer 32 and the outer metal reinforcing layer 34 is described, but general-purpose nylon (aliphatic polyamide fiber) represented by nylon 66, nylon 6 or the like may be a layer obtained by being covered by rubber having higher hardness than the carcass rubber or the covering rubber configuring the inner metal reinforcing layer 32 and the outer metal reinforcing layer 34.

Although the embodiments of the invention have been described above, the embodiments are presented by way of examples and are not intended to limit the scope of the invention. Novel embodiments can be implemented in various other forms and various omissions, substitutions, and changes can be made without departing from the gist of the invention.

### EXAMPLES

In order to concretely illustrate the configurations and the effects of the embodiments, an evaluation method in which a pneumatic tire having a tire size of 11R22.5 was produced and performance evaluation was carried out is as follows.

### (1) Bead Durability Test

Under conditions of air pressure 850 kPa, load 29.4 kN, and speed 50 km/h, a test tire was run on a drum having a diameter of 1700 mm until it failed. A run distance of Comparative Example 1 was set to 100 as an index. The larger the numerical value, the better the index.

### (2) Wear Resistance Test of Rim Contact Portion

Under the conditions of air pressure 850 kPa and load 29.4 kN, the test tire was run for 50,000 km and a thickness of a rim contact portion in the rim strip 25 was measured. The thickness before the start of running was 4 mm. The closer the numerical value is to 4 mm, the less the wear and the better.

A prototype tire with which the performance evaluation was performed is as follows. Moreover, in each of the prototype tires, the rubber hardness of rubber materials configuring the carcass ply 18, the inner metal reinforcing layer 32, the outer metal reinforcing layer 34, and the buffer layer 36, and the lengths from the nominal diameter to the end portions of the carcass ply 18, the inner metal reinforcing layer 32, the outer metal reinforcing layer 34, and the buffer layer 36 are illustrated in Table 1.

### Example 1

Example 1 is the tire having the bead portion configuration illustrated in FIGS. 1 and 2 according to the first embodiment.

### Example 2

Example 2 is the tire having the bead portion configuration illustrated in FIG. 4 according to the second embodiment. The length H2in in the tire radial direction from the nominal diameter to the inside end 34Ein of the outer metal reinforcing layer 34 in the tire axial direction is different from Example 1, but the others are the same as those of Example 1.

### Comparative Example 1

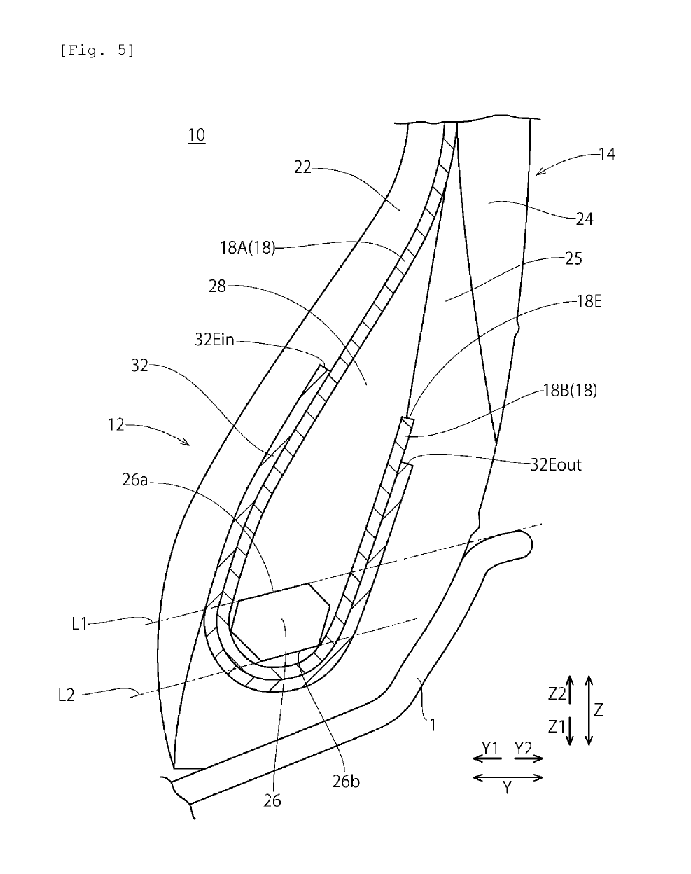

Comparative Example 1 is the tire illustrated in FIG. 5 and the inner metal reinforcing layer 32 is provided to overlap the carcass ply 18 so as to cover the outside of the carcass ply 18 around the bead core 26, but the outer metal reinforcing layer 34 or the buffer layer 36 is not provided. The others are the same as those of Example 1.

### Comparative Example 2

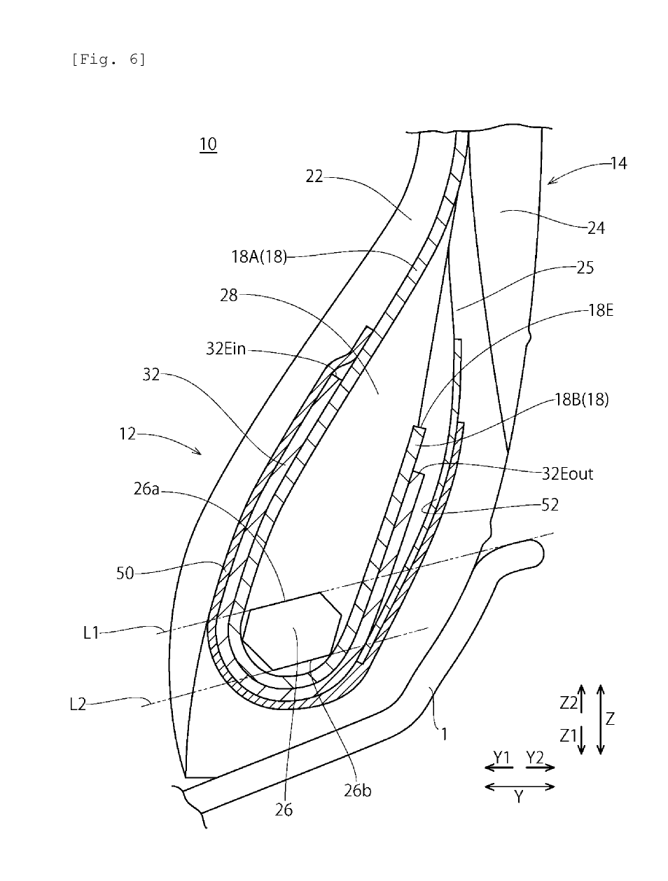

Comparative Example 2 is the tire illustrated in FIG. 6 and the inner metal reinforcing layer 32 is provided to overlap the carcass ply 18 so as to cover the outside of the carcass ply 18 around the bead core 26, but the outer metal reinforcing layer 34 or the buffer layer 36 is not provided. In Comparative Example 2, a first nylon reinforcing layer 50 obtained by covering a nylon fiber cord with the covering rubber is provided so as to cover the outside of the inner metal reinforcing layer 32 and a second nylon reinforcing layer 52 obtained by covering a nylon fiber cord with the covering rubber along the inside Y1 of the first nylon reinforcing layer 50 in the tire axial direction is provided. The others are the same as those of Example 1.

### Comparative Example 3

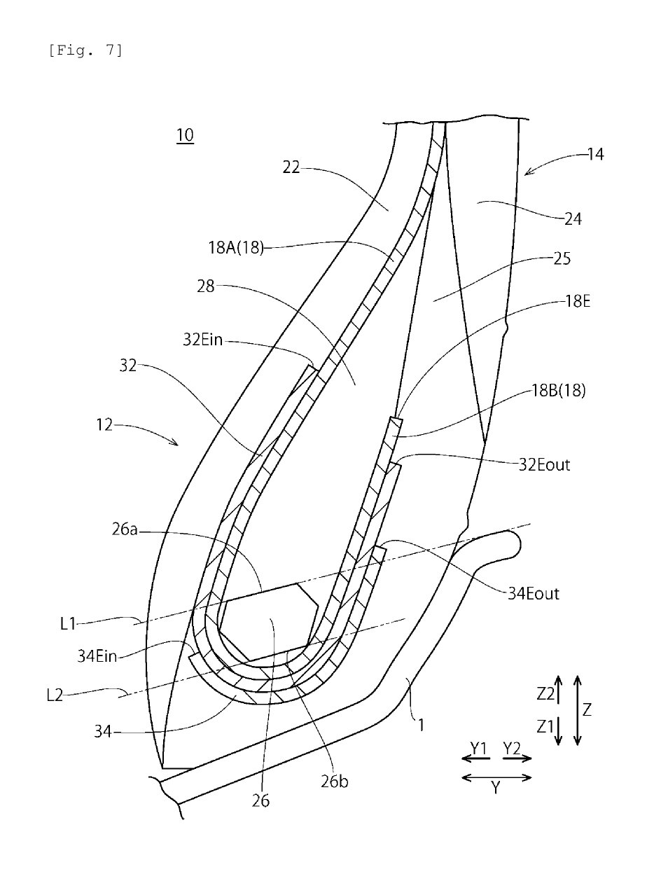

Comparative Example 3 is the tire illustrated in FIG. 7 and the inner metal reinforcing layer 32 is provided to overlap the carcass ply 18 so as to cover the outside of the carcass ply 18 around the bead core 26, and the outer metal reinforcing layer 34 is provided so as to cover the outside of the inner metal reinforcing layer 32, but the buffer layer 36 is not provided between the inner metal reinforcing layer 32 and the outer metal reinforcing layer 34. The others are the same as those of Example 1.

TABLE 1

| | | Comparative | Comparative | Comparative | | |
|---|---|---|---|---|---|---|
| | | Example 1 | Example 2 | Example 3 | Example 1 | Example 2 |
| Rubber | Carcass | 75 | 75 | 75 | 75 | 75 |
| hardness | Inner metal | 75 | 75 | 75 | 75 | 75 |
| | reinforcing layer | | | | | |
| | Outer metal | — | — | 75 | 75 | 75 |
| | reinforcing layer | | | | | |
| | Buffer layer | — | — | — | 85 | 85 |

| | | | | | |
|---|---|---|---|---|---|
| H0 (mm) | 38 | 38 | 38 | 38 | 38 |
| H1in (mm) | 45 | 45 | 45 | 45 | 45 |
| H1out (mm) | 30 | 30 | 30 | 30 | 30 |
| H2in (mm) | — | — | 5 | 5 | 10 |
| H2out (mm) | — | — | 20 | 20 | 20 |
| H3in (mm) | — | — | — | 15 | 15 |
| H3out (mm) | — | — | — | 25 | 25 |
| Bead durability | 100 | 120 | 130 | 140 | 150 |
| Wear resistance property (mm) | 3 | 3.3 | 3.5 | 3.9 | 3.9 |

The results are illustrated in Table 1. In Examples 1 and 2, in which the buffer layer 36 is provided between the inner metal reinforcing layer 32 and the outer metal reinforcing layer 34, the bead durability and wear resistance performance of the rim contact portion were greatly improved as compared to Comparative Example 1 or Comparative Examples 2 and 3 in which the nylon reinforcing layers 50 and 52, or the outer metal reinforcing layer 34 is additionally provided to Comparative Example 1. In Example 2, in which the inside end 34Ein of the outer metal reinforcing layer 34 in the tire axial direction is disposed on the outside Z2 in the tire radial direction from the bead upper side line L1, the bead durability was further improved as compared to Example 1.

What is claimed is:

1. A pneumatic tire comprising:
a bead core that is embedded in a bead portion;
a bead filler that is disposed on an outside of the bead core in a tire radial direction;
a carcass ply that is wound up around the bead core from an inside to the outside in a tire axial direction;
an inner metal reinforcing layer that is wound up on an outside of the carcass ply from the inside to the outside in the tire axial direction;
an outer metal reinforcing layer that is wound up on an outside of the inner metal reinforcing layer from the inside to the outside in the tire axial direction; and
a buffer layer that is provided between the inner metal reinforcing layer and the outer metal reinforcing layer, and is wound up from the inside to the outside in the tire axial direction,
wherein the carcass ply includes a ply cord and a carcass rubber covering the ply cord, the inner metal reinforcing layer and the outer metal reinforcing layer include metal cords and covering rubbers that cover the metal cords, and the buffer layer includes a rubber having a higher hardness than those of the carcass rubber and the covering rubber.

2. The pneumatic tire according to claim 1,
wherein an outside end of the inner metal reinforcing layer in the tire axial direction, an outside end of the buffer layer in the tire axial direction, and the outside end of the outer metal reinforcing layer in the tire axial direction are positioned outward in the tire radial direction from a bead upper side line extending from an outside surface of the bead core in the tire radial direction, and
wherein the outside end of the inner metal reinforcing layer in the tire axial direction is positioned outward in the tire radial direction from the outside end of the buffer layer in the tire axial direction, and the outside end of the buffer layer in the tire axial direction is positioned outward in the tire radial direction from the outside end of the outer metal reinforcing layer in the tire axial direction.

3. The pneumatic tire according to claim 1,
wherein an inside end of the inner metal reinforcing layer in the tire axial direction, an inside end of the buffer layer in the tire axial direction, and an inside end of the outer metal reinforcing layer in the tire axial direction are positioned outward in the tire radial direction from a bead upper side line extending from the outside surface of the bead core in the tire radial direction, and
wherein the inside end of the inner metal reinforcing layer in the tire axial direction is positioned outward in the tire radial direction from the inside end of the buffer layer in the tire axial direction, and the inside end of the buffer layer in the tire axial direction is positioned outward in the tire radial direction from the inside end of the outer metal reinforcing layer in the tire axial direction.

4. The pneumatic tire according to claim 2,
wherein a winding-up end of the carcass ply is positioned outward in the tire radial direction from the outside end of the inner metal reinforcing layer in the tire axial direction.

5. The pneumatic tire according to claim 3,
wherein the inside end of the inner metal reinforcing layer in the tire axial direction is positioned outward in the tire radial direction from a winding-up end of the carcass ply, and
wherein the winding-up end of the carcass ply is positioned outward in the tire radial direction from the inside end of the outer metal reinforcing layer in the tire axial direction.

6. The pneumatic tire according to claim 1,
wherein the inner metal reinforcing layer, the outer metal reinforcing layer, and the buffer layer face an entire portion being in contact with a rim strip with the rim strip interposed therebetween in a rim flange, in a state of being mounted on the rim flange.

7. The pneumatic tire according to claim 1,
wherein the metal cord of the inner metal reinforcing layer and the metal cord of the outer metal reinforcing layer are inclined with respect to the ply cord in the opposite direction to each other.

8. The pneumatic tire according to claim 7,
wherein an angle between the metal cord of the inner metal reinforcing layer and the metal cord of the outer metal reinforcing layer is 50° or more and 105° or less.

9. The pneumatic tire according to claim 2,
wherein the inside end of the inner metal reinforcing layer in the tire axial direction, the inside end of the buffer layer in the tire axial direction, and the inside end of the outer metal reinforcing layer in the tire axial direction are positioned outward in the tire radial direction from the bead upper side line extending from the outside surface of the bead core in the tire radial direction, and
wherein the inside end of the inner metal reinforcing layer in the tire axial direction is positioned outward in the tire radial direction from the inside end of the buffer layer in the tire axial direction, and the inside end of the buffer layer in the tire axial direction is positioned outward in the tire radial direction from the inside end of the outer metal reinforcing layer in the tire axial direction.

10. The pneumatic tire according to claim 6,
wherein the inside end of the inner metal reinforcing layer in the tire axial direction is positioned outward in the tire radial direction from the winding-up end of the carcass ply, and
wherein the winding-up end of the carcass ply is positioned outward in the tire radial direction from the inside end of the outer metal reinforcing layer in the tire axial direction.
